(19) United States
(12) Patent Application Publication
(10) Pub. No.: US 2026/0005348 A1
(43) Pub. Date: Jan. 1, 2026

(54) SECONDARY BATTERY AND METHOD OF MANUFACTURING SAME

(71) Applicant: Samsung SDI Co., Ltd., Yongin-si (KR)

(72) Inventor: Taewoong Jang, Yongin-si (KR)

(73) Assignee: Samsung SDI Co., Ltd., Yongin-si (KR)

(21) Appl. No.: 18/927,682

(22) Filed: Oct. 25, 2024

(30) Foreign Application Priority Data
Jun. 27, 2024 (KR) 10-2024-0084682

(51) Int. Cl. H01M 50/166; H01M 10/04; H01M 50/109; H01M 50/153; H01M 50/559

(52) U.S. Cl. CPC H01M 50/166; H01M 10/049; H01M 50/109; H01M 50/153; H01M 50/559

(57) ABSTRACT

A secondary battery may include an electrode assembly comprising a first electrode, a separator, and a second electrode; a receiving can having an open first side to receive the electrode assembly and the receiving can being connected to the first electrode; and a cap assembly configured to seal the open first side of the receiving can and being connected to the second electrode. The first electrode may include a first substrate tab that is a bent portion of a first substrate not coated with an active material at a first end of the first electrode disposed on an outer circumferential surface of the electrode assembly, and the first substrate tab may be disposed between the electrode assembly and an inner first surface of the receiving can.

### CROSS-REFERENCE TO RELATED APPLICATIONS

This present application claims priority to and the benefit under 35 U.S.C § 119 (a)-(d) of Korean Patent Application No. 10-2024-0084682, filed on Jun. 27, 2024, in the Korean Intellectual Property Office, the entire disclosure of which is incorporated herein by reference.

### FIELD

The present disclosure relates to a secondary battery and a method of manufacturing the same.

### BACKGROUND

Recently, the growing demand for wearable devices such as Bluetooth-enabled headphones, earphones, smart watches, and body-worn medical devices has increased the demand for ultra-small secondary batteries having a high energy density and a sufficiently small size. Such secondary batteries are significantly smaller in height than width, depending on the nature of applications, and may include coin batteries and button batteries.

The above information disclosed in this Background section is for enhancement of understanding of the background of the present disclosure, and therefore, it may contain information that does not constitute related (or prior) art.

### SUMMARY

The present disclosure is intended to provide a secondary battery and a method of manufacturing the secondary battery to overcome the problems described herein.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

According to an embodiment of the present disclosure to solve the above technical problem, a secondary battery may include: an electrode assembly comprising a first electrode, a separator, and a second electrode; a receiving can having an open first side to receive the electrode assembly and the receiving can being connected to the first electrode; and a cap assembly configured to seal the open first side of the receiving can and being connected to the second electrode, wherein the first electrode includes a first substrate tab that is a bent portion of a first substrate not coated with an active material at a first end of the first electrode disposed on an outer circumferential surface of the electrode assembly, and the first substrate tab is disposed between the electrode assembly and an inner first surface of the receiving can.

According to one or more embodiments, the first substrate tab may be first bent so that the first substrate disposed on the outer circumferential surface of the electrode assembly faces an inner bottom of the receiving can and may be subsequently bent so that the first substrate is disposed between a bottom surface of the electrode assembly and the inner bottom of the receiving can.

According to one or more embodiments, the secondary battery may further include a first close contact member disposed between the electrode assembly and the first substrate tab.

According to one or more embodiments, the first close contact member may include a resilient insulator.

According to one or more embodiments, the first close contact member may include a resilient porous material.

According to one or more embodiments, the first substrate tab may be brought into contact with the inner first surface of the receiving can by pressure transmitted from the electrode assembly during coupling between the cap assembly and the receiving can.

According to one or more embodiments, the second electrode May include a second substrate tab that is a bent portion of a second substrate not coated with an active material at a first end of the second electrode disposed on the outer circumferential surface of the electrode assembly, and the second substrate tab may be disposed between the electrode assembly and an inner first surface of the cap assembly.

According to one or more embodiments, the second substrate tab may be first bent so that the second substrate disposed on the outer circumferential surface of the electrode assembly faces the inner first surface of the cap assembly and may be subsequently bent so that the bent second substrate is disposed between a top surface of the electrode assembly and the inner first surface of the cap assembly.

According to one or more embodiments, the secondary battery may further include a second close contact member disposed between the electrode assembly and the second substrate tab.

According to one or more embodiments, the second close contact member may include a resilient insulator.

According to one or more embodiments, the second close contact member may include a resilient porous material.

According to one or more embodiments, the second substrate tab may be brought into contact with the inner first surface of the cap assembly by pressure transmitted from the electrode assembly during coupling between the cap assembly and the receiving can.

According to one or more embodiments, the cap assembly may include: a terminal plate connected to the second electrode; a cap plate configured to have a first open area and bonded to the open first side of the receiving can; and a cap insulating layer configured to include a second open area and disposed between the terminal plate and the cap plate to insulate between the terminal plate and the cap plate.

According to one or more embodiments, the terminal plate may include: a body connected to the second electrode; and a protrusion configured to protrude upward from a central portion of the body to extend through the first open area of the cap plate.

According to one or more embodiments, a diameter of the body of the terminal plate may be greater than a diameter of the outer circumferential surface of the electrode assembly.

According to one or more embodiments of the present disclosure, a method of manufacturing a secondary battery, the method may include: forming an electrode assembly comprising a first electrode, a separator, and a second electrode; forming a first substrate tab by bending a first substrate not coated with an active material at a first end of the first electrode disposed on an outer circumferential surface of the electrode assembly; disposing the first substrate tab between the electrode assembly and an inner first surface of a receiving can having an open first side while receiving the electrode assembly in the receiving can having the open first side; and connecting the second electrode and a cap assembly together while sealing the open first side of the receiving can with the cap assembly.

According to one or more embodiments, the forming of the first substrate tab may include: first bending the first substrate tab so that the first substrate disposed on the outer circumferential surface of the electrode assembly faces an inner bottom of the receiving can; and subsequently bending the first substrate tab so that the bent first substrate is disposed between a bottom surface of the electrode assembly and the inner bottom of the receiving can.

According to one or more embodiments, wherein in sealing the open first side of the receiving can with the cap assembly, the first substrate tab may be brought into contact with the inner first surface of the receiving can by pressure transmitted from the electrode assembly during coupling between the cap assembly and the receiving can.

According to one or more embodiments, method of manufacturing a secondary battery may further include providing a first close contact member between the electrode assembly and the first substrate tab.

According to one or more embodiments, method of manufacturing a secondary battery may further include forming a second substrate tab by bending a second substrate not coated with an active material at a first end of the second electrode disposed on the outer circumferential surface of the electrode assembly, wherein the connecting of the second electrode and the cap assembly while sealing the open first side of the receiving can with the cap assembly includes disposing the second substrate tab between the electrode assembly and an inner first surface of the cap assembly while connecting the open first side of the receiving can to the cap assembly.

According to some embodiments of the present disclosure, a substrate tab may be formed from a substrate of an electrode plate included in an electrode assembly of a secondary battery without connecting a collector tab to the electrode assembly, and the formed substrate tab may be directly connected to an electrode. Accordingly, the substrate tab may act as a pressure point on the electrode plate of the electrode assembly, thereby reducing cracks in the electrode plate.

According to some embodiments of the present disclosure, by disposing the resilient close contact member between the electrode assembly and the receiving can and/or between the electrode assembly and the cap assembly, close connection between the substrate tab of the electrode plate and the electrode may be maintained.

According to some embodiments of the present invention, by disposing the resilient close contact member between the electrode assembly and the receiving can and/or between the electrode assembly and the cap assembly, damage to the internal components of the secondary cell due to external impacts, such as vibration or dropping, on the secondary cell may be prevented.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 illustrates a perspective view showing a secondary battery according to an embodiment of the present disclosure.

FIG. 2 illustrates an exploded perspective view showing the secondary battery according to an embodiment of the present disclosure.

FIG. 3 illustrates a cross-sectional view showing the secondary battery according to an embodiment of the present disclosure.

FIG. 4 illustrates a process of forming a first substrate tab according to some embodiments of the present disclosure.

FIG. 5 illustrates a process of forming a second substrate tab according to some embodiments of the present disclosure.

FIG. 6 illustrates a cross-sectional view showing the terminal plate according to some embodiments.

FIG. 7 illustrates an exploded perspective view showing the cap assembly 400 according to some embodiments.

FIG. 8 illustrates the connection relationship between the cap assembly and the electrode assembly according to some embodiments.

FIG. 9 illustrates the connection relationship between the electrode assembly and the receiving can according to some embodiments.

FIG. 10 illustrates a flowchart for explaining a method of manufacturing a secondary battery according to some embodiments.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. May be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise.

It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

In secondary batteries, a collector tab connected to an electrode assembly may act as a pressure point on an electrode plate which can be a problem factor that causes cracks in the electrode plate. In addition, during operation of the secondary battery, external shocks such as vibration and dropping may cause cracks in the electrode plate. Aspects of the technology described herein address such problems.

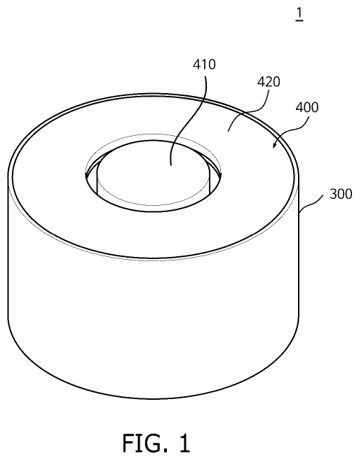

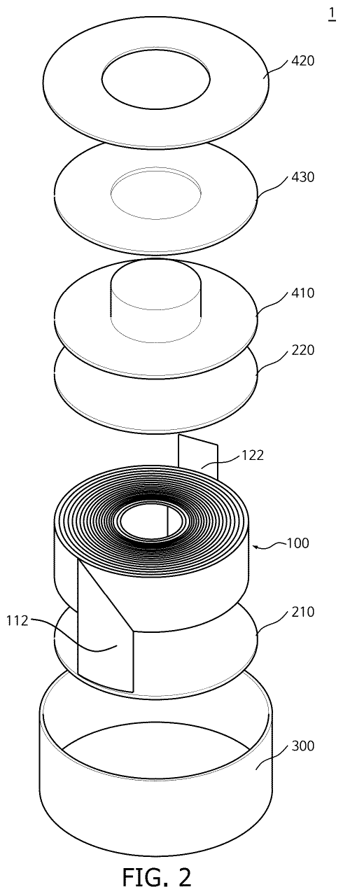

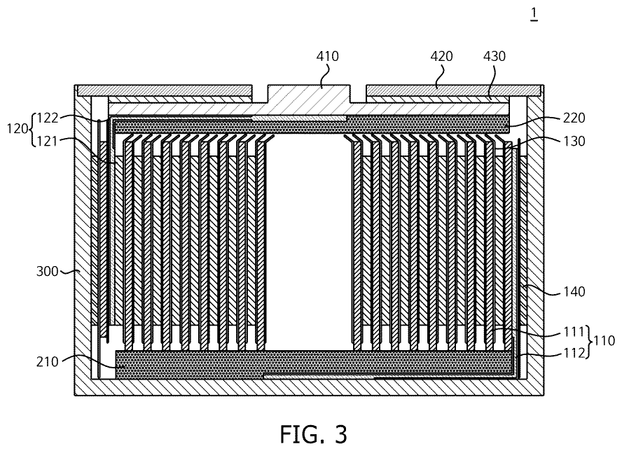

FIG. 1 illustrates a perspective view showing a secondary battery according to an embodiment of the present disclosure. FIG. 2 illustrates an exploded perspective view showing the secondary battery according to an embodiment of the present disclosure. FIG. 3 illustrates a cross-sectional view showing the secondary battery according to an embodiment of the present disclosure.

A secondary battery according to one or more embodiments is a micro-sized secondary battery and may be a coin cell or a button cell but is not limited thereto and may be a cylindrical or pin-type battery.

The coin cell or button cell is a battery in the form of a thin coin or button and may refer to a battery having a ratio of height to diameter (height/diameter) of 1 or less but the present disclosure is not limited thereto. Because the coin cell or button cell is generally cylindrical, the cross section in the horizontal direction is generally circular. However, the cross section in the horizontal direction is not limited thereto and may have an elliptical or polygonal shape. The diameter may refer to a maximum distance in the horizontal direction of the battery, and the height may refer to a maximum distance in the vertical direction of the battery (e.g., distance from the flat bottom surface to the flat top surface of the battery).

Referring to FIGS. 1 to 3, a secondary battery 1 according to an embodiment of the present disclosure may include an electrode assembly 100, a first close contact member 210, a second close contact member 220, a receiving can 300, and a cap assembly 400.

According to an embodiment, the electrode assembly 100 may include a first electrode 110, a second electrode 120, and a separator 130. Herein, the first electrode 110 may be a negative electrode, and the second electrode 120 may be a positive electrode. The reverse is also possible. For example, the electrode assembly 100 may be a wound electrode assembly 100 formed by providing a separator 130 formed of an insulator between the first electrode 110 and the second electrode 120, followed by winding. In another example, the electrode assembly 100 may be a laminated electrode assembly 100 formed by alternately stacking the first electrode 110 and the second electrode 120 with the separator 130 provided therebetween, or may be any structure including the first electrode 110 and the second electrode 120. The structure of the electrode assembly 100 described above is illustrative, and the present disclosure is not limited thereto. However, for ease of explanation, the following description will focus on the wound electrode assembly 100.

According to an embodiment, the first electrode 110 may include a coated portion 111 provided in a region where an active material is applied to opposite surfaces of a first substrate formed of a thin metal plate and an uncoated portion provided in a region where the active material is not applied to the first substrate. The first electrode 110 may include the uncoated portion provided on opposite surfaces of the first substrate in a winding longitudinal direction. In addition, the first electrode 110 may include an uncoated portion provided by a predetermined length at a first end disposed on the outer surface of the electrode assembly 100. As described herein, the uncoated portion provided at the first end of the first electrode 110 may be bent to form a first substrate tab 112. The first electrode 110 may be formed by coating a metal substrate formed of, for example, copper, a copper alloy, nickel, or a nickel alloy, with a cathode active material such as graphite or carbon to form a cathode.

According to an embodiment, the first electrode 110 may be connected to the receiving can 300. The receiving can 300 connected to the first electrode 110 may function as a negative electrode.

According to an embodiment, the second electrode 120 may include coated portion 121 provided in regions in which an active material is applied to opposite surfaces of a second substrate formed of a thin metal plate and uncoated portion provided in regions in which the active material is not applied to the first substrate. The second electrode 120 may include the uncoated portion provided on opposite surfaces of the second substrate in a winding longitudinal direction. In addition, the second electrode 120 may include an uncoated portion provided by a predetermined length at a first end disposed on the outer surface of the electrode assembly 100. As is described herein, the uncoated portion provided at the first end of the second electrode 120 may be bent to form a second substrate tab 122. The second electrode 120 may be formed by coating 10) a metal substrate such as aluminum or an aluminum alloy with a positive electrode active material, such as a transition metal oxide.

According to an embodiment, the second electrode 120 may be connected to a cap assembly 400. The cap assembly 400 connected to the second electrode 120 may function as a positive electrode.

According to one embodiment, the first electrode 1100 may be a negative electrode. The negative electrode for a rechargeable lithium battery may include a current collector and a negative electrode active material layer on the current collector. The negative electrode active material layer may include a negative electrode active material, and may further include a binder and/or a conductive material (e.g., an electrically conductive material).

The negative electrode active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example. crystalline carbon, amorphous carbon or a combination thereof. The crystalline carbon may be graphite such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOx (0<x<2), a Si-Q alloy (where Q is selected from an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnO₂, a Sn-based alloy, or a combination thereof.

The silicon-carbon composite may be a composite of silicon and amorphous carbon. According to an embodiment, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

For example, the negative electrode active material layer may include about 90 wt % to about 99 wt % of the negative electrode active material, about 0.5 wt % to about 5 wt % of the binder, and about 0 wt % to about 5 wt % of the conductive material.

The binder may serve to attach the negative electrode active material particles well to each other and also to attach the negative electrode active material well to the current collector. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be selected from a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is used as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include Na, K, or Li.

The dry binder may be a polymer material that is capable of being fibrous. For example, the dry binder may be polytetrafluoroethylene, polyvinylidene fluoride, a polyvinylidene fluoride-hexafluoropropylene copolymer, polyethylene oxide, or a combination thereof.

The conductive material may be used to impart conductivity (e.g., electrical conductivity) to the electrode. Any material that does not cause chemical change (e.g., does not cause an undesirable chemical change in the rechargeable lithium battery) and that conducts electrons can be used in the battery. Non-limiting examples thereof may include a carbon-based material such as natural graphite, artificial graphite, carbon black, acetylene black, ketjen black, a carbon fiber, a carbon nanofiber, and a carbon nanotube; a metal-based material including copper, nickel, aluminum, silver, etc. in a form of a metal powder or a metal fiber; a conductive polymer such as a polyphenylene derivative; or a mixture thereof.

The negative current collector may include a copper foil, a nickel foil, a stainless steel foil, a titanium foil, a nickel foam, a copper foam, a polymer substrate coated with a conductive metal, or a combination thereof.

According to one embodiment, the second electrode 1200 may be a positive electrode. The positive electrode for a rechargeable lithium battery may include a current collector and a positive electrode active material layer on the current collector. The positive electrode active material layer may include a positive electrode active material and may further include a binder and/or a conductive material (e.g., an electrically conductive material).

The positive electrode active material may include a compound (lithiated intercalation compound) that is capable of intercalating and deintercalating lithium. Specifically, at least one of a composite oxide of lithium and a metal selected from cobalt, manganese, nickel, and combinations thereof may be used.

The composite oxide may be a lithium transition metal composite oxide. Specific examples of the composite oxide may include lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiaA1-bXbO2-cDc (0.90≤a≤1.8, 0≤b≤0.5, and 0≤c≤0.05); LiaMn2-bXbO4-cDc (0.90≤a≤1.8, 0≤b≤0.5, and 0≤c≤0.05); LiaNi1-b-cCobXcO2-αDa (0.90≤a≤1.8, 0≤b≤0.5, 0≤c≤0.5, and 0<α<2); LiaNi1-b-cMnbXcO2-αDa (0.90≤a≤1.8, 0≤b≤0.5, 0≤c≤0.5, and 0<α<2); LiaNibCocL1dGeO2 (0.90≤a≤1.8, 0≤b≤0.9, 0≤c≤0.5, 0≤d≤0.5, and 0≤e≤0.1); LiaNiGbO2 (0.90≤a≤1.8 and 0.001≤b≤0.1); LiaCoGbO2 (0.90≤a≤1.8 and 0.001≤b≤0.1); LiaMn1-bGbO2 (0.90≤a≤1.8 and 0.001≤b≤0.1); LiaMn2GbO4 (0.90≤a≤1.8 and 0.001≤b≤0.1); LiaMn1-gGgPO4 (0.90≤a≤1.8 and 0≤g≤0.5); Li(3-f)Fe2(PO4)3 (0≤f≤2); or LiaFePO4 (0.90≤a≤1.8).

In the above Chemical Formulas, A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L1 is Mn, Al, or a combination thereof.

The positive electrode active material may be, for example, a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity and can be applied to a high-capacity, high-density rechargeable lithium battery.

For example, the positive electrode may further include an additive that can serve as a sacrificial positive electrode.

An amount of the positive electrode active material may be about 90 wt % to about 99.5 wt % based on 100 wt % of the positive electrode active material layer. Amounts of the binder and the conductive material may be about 0.5 wt % to about 5 wt %, respectively, based on 100 wt % of the positive electrode active material layer.

The binder serves to attach the positive electrode active material particles well to each other and also to attach the positive electrode active material well to the current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may be used to impart conductivity (e.g., electrical conductivity) to the electrode. Any material that does not cause chemical change (e.g., does not cause an undesirable chemical change in the rechargeable lithium battery) and conducts electrons can be used in the battery. Examples of the conductive material may include a carbon-based material such as natural graphite, artificial graphite, carbon black, acetylene black, ketjen black, a carbon fiber, a carbon nanofiber, and carbon nanotube; a metal-based material containing copper, nickel, aluminum, silver, etc., in a form of a metal powder or a metal fiber; a conductive polymer such as a polyphenylene derivative; or a mixture thereof.

Al may be used as the current collector, but the present disclosure is not limited thereto.

According to an embodiment, the first electrode 110 may include the first substrate tab 112. The first substrate tab 112 may be formed by bending the uncoated portion provided by a predetermined length at the first end of the first electrode 110. The first substrate tab 112 may first be bent to face the inner bottom of the receiving can 300, and may be subsequently be bent to be disposed between the bottom surface of the electrode assembly 100 and the inner bottom of the receiving can 300. The first material tab 112 may be disposed between the electrode assembly 100 and an inner first surface of the receiving can 300. The first substrate tab 112 may be positioned between the bottom surface of the electrode assembly 100 and the inner bottom of the receiving can 300 and be closely connected to the receiving can 300 by pressure applied by the electrode assembly 100. That is, the first substrate tab 112 may be electrically connected to the inner bottom of the receiving can 300 by pressure applied by the electrode assembly 100 without a separate bonding process such as welding.

In addition, the first close contact member 210 may be disposed between the first substrate tab 112 and the bottom surface of the electrode assembly. In this case, the first substrate tab 112 may be disposed on the lower surface of the first close contact member 210. The first substrate tab 112 may be positioned on the lower surface of the first close contact member 210 and be closely connected to the receiving can 300 by pressure applied by the first close contact member 210. In other words, the first substrate tab 112 may be electrically connected to the inner bottom of the receiving can 330 by pressure applied by the first close contact member 210 without a separate bonding process such as welding.

According to the configuration described above, the first substrate tab 112 may function as an electrode tab. The first electrode 110 and the receiving can 300 may be electrically connected through the first substrate tab 112.

According to an embodiment, the second electrode 120 may include the second substrate tab 122. The second substrate tab 122 may be formed by bending the uncoated portion of the second electrode 120 provided by a predetermined length at the first end of the second electrode 120. The second substrate tab 122 may first be bent to face an inner first surface of the cap assembly 400, and may subsequently be bent to be disposed between the upper surface of the electrode assembly 100 and the inner first surface of the cap assembly 400. The second substrate tab 122 may be connected to the cap assembly 400. The second substrate tab 122 may be disposed on the upper surface of the second close contact member 220. The second substrate tab 122 may be disposed between the electrode assembly 100 and the inner first surface of the cap assembly 400. The second substrate tab 122 may be disposed between the electrode assembly 100 and the inner first surface of the cap assembly 400, and may be closely connected to the receiving can 300 by pressure applied by the electrode assembly 100. That is, the second substrate tab 122 may be electrically connected to the inner first surface of the cap assembly 400 by pressure applied by the electrode assembly 100 without a separate bonding process such as welding.

In addition, the second close contact member 220 may be disposed between the second substrate tab 122 and the top surface of the electrode assembly 100. In this case, the second substrate tab 122 may be disposed on the upper surface of the second close contact member 220. The second substrate tab 122 may be positioned on the upper surface of the second close contact member 220, and may be closely connected to the cap assembly 400 by pressure applied by the second close contact member 220. That is, the second substrate tab 122 may be electrically connected to the inner first surface of the cap assembly 400 by pressure applied by the second close contact member 220 without a separate bonding process such as welding.

According to the configuration described above, the second substrate tab 122 may function as an electrode tab, and the second electrode 120 and the cap assembly 400 may be electrically connected through the second substrate tab 122.

According to an embodiment, the separator 130 may be positioned between the first electrode 110 and the second electrode 120. The separator 130 may insulate the first electrode 110 and the second electrode 120, and may allow lithium ions to be exchanged between the first electrode 110 and the second electrode 120. The separator membrane 130 may have a sufficient length to completely insulate the first electrode 110 and the second electrode 120 even in the case that the electrode assembly 100 contracts or expands during the charging and discharging process of the secondary battery 1.

According to an embodiment, the secondary battery 1 may further include seal tape 140. The seal tape 140 may be attached to the outer surface of the electrode assembly 100 to prevent loosening and movement of the electrode assembly 100.

According to an embodiment, the first close contact member 210 may be disposed between the electrode assembly 100 and the receiving can 300. The first close contact member 210 may be disposed on the underside of the electrode assembly 100 with respect to the winding axis of the electrode assembly 100.

According to an embodiment, the first close contact member 210 may force the first substrate tab 112 and the receiving can 300 into close contact. The first close contact member 210 may be compressed between the electrode assembly 100 and the receiving can 300 by pressure transmitted from the cap assembly 400, thereby forcing the first substrate tab 112 and the receiving can 300 into close contact.

According to an embodiment, the first close contact member 210 may include a resilient insulator. The first close contact member 210 may be a resilient material that may be compressed by pressure transmitted from the cap assembly 400. The first close contact member 210 may be an insulator that prevents a short circuit from occurring between components of the electrode assembly 100 other than the second electrode 120 and the receiving can 300. The first close contact member 210 may be a resilient insulator including, but not limited to, rubber, silicone, polymer, or the like.

According to an embodiment, the first close contact member 210 may include a resilient porous material. The first close contact member 210 may be a porous material that may be compressed to force the first substrate tab 112 and the receiving can 300 into close contact and may contain an electrolyte. The first close contact member 210 may be a porous material having a sponge structure, a honeycomb structure, or various shapes of pores, but the present disclosure is not limited thereto.

According to an embodiment, the second close contact member 220 may be disposed between the electrode assembly 100 and the cap assembly 400. The second close contact member 220 may be disposed on the upper surface of the electrode assembly 100 with respect to the winding axis of the electrode assembly 100.

According to an embodiment, the second close contact member 220 may force the second substrate tab 122 and the cap assembly 400 into close contact. The second close contact member 220 may be compressed between the cap assembly 400 and the electrode assembly 100 by pressure transmitted from the electrode assembly 100 or the cap assembly 400, thereby forcing the second substrate tab 122 and the cap assembly 400 into close contact.

According to an embodiment, the second close contact member 220 may include a resilient insulator. The second close contact member 220 may be a resilient material that may be compressed by pressure transmitted from the electrode assembly 100 or the cap assembly 400. The second close contact member 220 may be an insulator that prevents a short circuit from occurring between components of the electrode assembly 100 other than the first electrode 110 and the cap assembly 400. The second close contact member 220 may be an elastomeric insulator including, but is not limited to, rubber, silicone, polymer, or the like.

According to an embodiment, the second close contact member 220 may include a resilient porous material. The second close contact member 220 may be a porous material that may be compressed to force the second substrate tab 122 and the cap assembly 400 into close contact with each other and may contain an electrolyte. The second close contact member may be a porous material having a sponge structure, a honeycomb structure, or various shapes of pores, but the present disclosure is not limited thereto.

According to an embodiment, the receiving can 300 may have an open first side to receive the electrode assembly 100 and may be electrically connected to the first electrode 110. The receiving can 300 may be connected to the first substrate tab 112. The receiving can 300 may be connected to the first electrode 110 through the first substrate tab 112 to function as a negative electrode.

According to an embodiment, the receiving can 300 may form the overall contour of the secondary battery 1. For example, the receiving can 300 may have an open cylindrical shape. The receiving can 300 may include a circular lower surface and a sidewall extending vertically from a circumference of the lower surface. The receiving can 300 may be formed such that the diameter of the lower surface is greater than the height of the sidewall, so that the secondary battery 1 may be implemented as a button or coin battery.

According to an embodiment, the upper surface of the receiving can 300 opposite the lower surface may be open to expose a receiving space capable of receiving the electrode assembly 100. After the electrode assembly 100 is received in the receiving can 300, the cap assembly 400 may cover an open first side of the receiving can 300 and seal the electrode assembly 100. Specifically, the upper surface of the sidewall of the receiving can 300 may have a portion that is stepped from the outside to the inside. For engagement with the stepped portion of the receiving can 300, the cap assembly 400 may be engaged and joined by metal bonding (e.g., welding, brazing, or soldering), but the present disclosure is not limited thereto.

According to an embodiment, the cap assembly 400 may seal the open first side of the receiving can 300. The cap assembly 400 may seal the electrode assembly 100 from the outside by covering the open first side of the receiving can 300. The cap assembly 400 may be electrically connected to the second electrode 120. The cap assembly 400 may be connected to the second electrode 120 through the second substrate tab 122 to function as a positive electrode.

According to an embodiment, the cap assembly 400 may include a terminal plate 410, a cap plate 420, and a cap insulating layer 430.

According to an embodiment, the terminal plate 410 may be connected to the second electrode 120. The terminal plate 410 may be disposed on the second close contact member 220. The second substrate tab 122 may be disposed between the terminal plate 410 and the second close contact member 220. The terminal plate 410 may be electrically connected to the second electrode 120 through the second substrate tab 122.

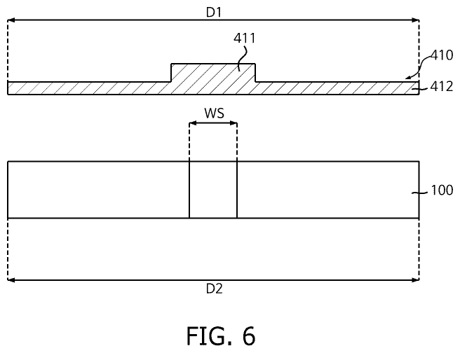

According to an embodiment, the cap insulating layer 430 and the cap plate 420 may be sequentially disposed on the terminal plate 410. The terminal plate 410 may include a protrusion 411 (see FIG. 6) protruding upward from the central region. The protrusion may protrude outward through a first open area of the cap plate 420 and a second open area of the cap insulating layer 430.

According to an embodiment, the cap plate 420 may be bonded to the open first side of the receiving can 300. The cap plate 420 may be seated on the outer wall of the receiving can 300 and may be bonded to the receiving can 300. The cap plate 420 may be disposed on the cap insulating layer 430.

According to an embodiment, the cap plate 420 may include a first open area. The cap plate 420 may have a disc shape centered on the first open area. The protrusion of the terminal plate 410 may extend through the first open area and may be connected to an external terminal.

According to an embodiment, the cap insulating layer 430 may be disposed on the terminal plate 410. The cap insulating layer 430 may be disposed between the terminal plate 410 and the cap plate 420 to insulate the terminal plate 410 and the cap plate 420. Because the terminal plate 410 is connected to the second electrode 120 and the cap plate 420 is in contact with the receiving can 300 connected to the first electrode 110, the cap insulating layer 430 may be disposed between the terminal plate 410 and the cap plate 420 to insulate between the terminal plate 410 and the cap plate 420.

According to an embodiment, the cap insulating layer 430 may include the second open area. The cap insulating layer 430 may have a disc shape centered on the second open area. The protrusion of the terminal plate 410 may extend through the second open area and may be connected to an external terminal.

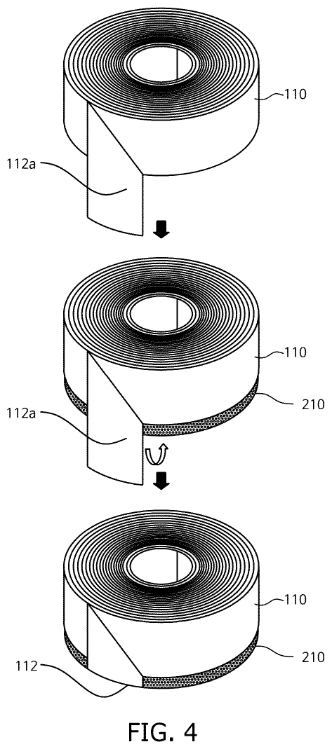

FIG. 4 illustrates a process of forming a first substrate tab according to some embodiments of the present disclosure.

Referring to FIG. 4, according to an embodiment, the first electrode 110 may include a first substrate 112a including an uncoated portion not coated with an active material at a first end disposed on the outer circumferential surface of the wound electrode assembly 100. On the outer circumferential surface of the electrode assembly 100, the first substrate 112a corresponding to the uncoated portion may be first bent downward. On the underside of the electrode assembly 100, the first close contact member 210 may be further disposed. Herein, the first close contact member 210 may include a resilient insulator. At the bottom of the first close contact member 210, the first-bent first substrate 112a may subsequently be bent toward the center of the first close contact member 210 (or toward the center of the inner bottom of the first close contact member 210). The second-bent first substrate 112a may be disposed on the underside of the first close contact member 210 to form the first substrate tab 112.

As described herein with reference to FIGS. 1 to 3, as the electrode assembly 100 is received in the receiving can 300, the first substrate tab 112 may be disposed between the first close contact member 210 and the receiving can 300. The receiving can 300 may be electrically connected to the first electrode 110 through the first substrate tab 112.

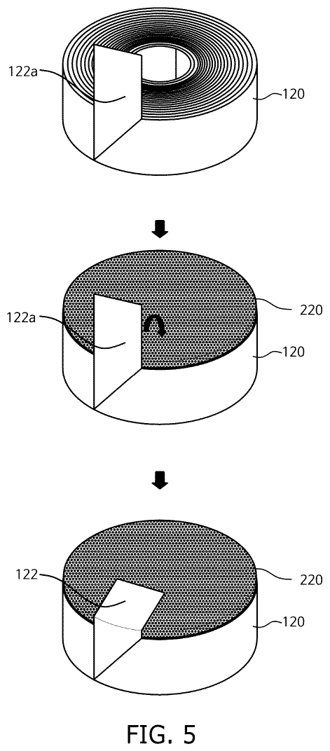

FIG. 5 illustrates a process of forming a second substrate tab according to some embodiments of the present disclosure.

Referring to FIG. 5, according to an embodiment, the second electrode 120 may include a second substrate 122a including an uncoated portion not coated with an active material at a first end disposed on the outer circumferential surface of the wound electrode assembly 100. On the outer circumferential surface of the electrode assembly 100, the second substrate 122a corresponding to the uncoated portion may be first bent upward. The second close contact member 220 may be further disposed on the upper surface of the electrode assembly 100. Herein, the second close contact member 220 may include a resilient insulator. At the top of the second close contact member 220, the first-bent second substrate 122a may subsequently be bent toward the center of the second close contact member 220. The second-bent second substrate 122a may be disposed on the upper surface of the second close contact member 220 to form the second substrate tab 122.

As described above with reference to FIGS. 1 to 3, as the cap assembly 400 seals the receiving can 300, the second substrate tab 122 may be disposed between the second close contact member 220 and the cap assembly 400. The cap assembly 400 may be electrically connected to the second electrode 120 through the second substrate tab 122.

FIG. 6 illustrates a cross-sectional view showing the terminal plate according to some embodiments.

Referring to FIG. 6, according to an embodiment, the terminal plate 410 may include a body 412 connected to the second electrode 120 and a protrusion 411 protruding upward from a central portion of the body 412.

According to an embodiment, the body 412 may have a shape corresponding to the first side of the electrode assembly 100. The diameter D1 of the body 412 may be greater than or equal to the diameter D2 of the electrode assembly 100.

The diameter D1 of the body 412 may be set greater than or equal to the diameter D2 of the electrode assembly 100, such that in the process of sealing the cap assembly 400 to the receiving can 300, the cap assembly 400 may apply downward pressure to sufficiently compress the first close contact member 210 and the second close contact member 220.

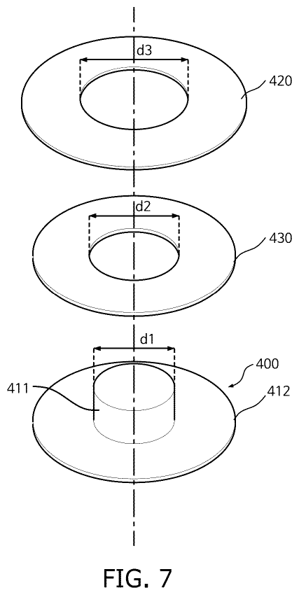

FIG. 7 illustrates an exploded perspective view showing the cap assembly 400 according to some embodiments.

Referring to FIG. 7, according to an embodiment, the protrusion 411 of the terminal plate 410 may be formed to protrude upward from a central portion of the body 412. The protrusion 411 may extend through the first open area of the cap plate 420.

According to an embodiment, the diameter d1 of the protrusion 411 of the terminal plate 410 may be set smaller than either the inner diameter d3 of the first open area of the cap plate 420 or the inner diameter d2 of the second open area of the cap insulating layer 430. The diameter d1 of the protrusion 411 of the terminal plate 410 may be set smaller than either the inner diameter d3 of the first open area or the inner diameter d2 of the second open area such that the protrusion 411 penetrates through the first open area and the second open area to be connected to the external terminal.

According to an embodiment, the inner diameter d2 of the second open area of the cap insulating layer 430 may be set smaller than the inner diameter d3 of the first open area of the cap plate 420. This configuration may prevent contact between the protrusion 411 of the terminal plate 410 and the first open area of the cap plate 420.

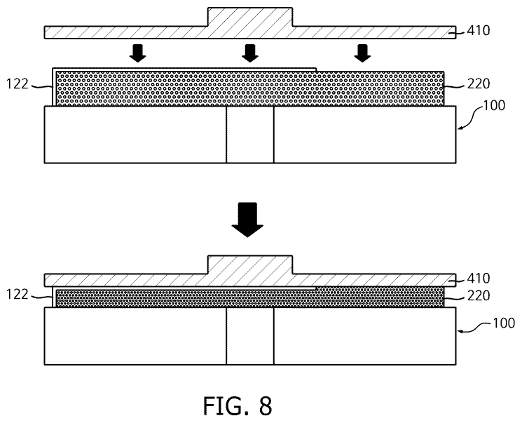

FIG. 8 illustrates the connection relationship between the cap assembly and the electrode assembly according to some embodiments.

Referring to FIG. 8, according to an embodiment, the second close contact member 220 may be disposed over the electrode assembly 100. The second substrate tab 122 may be bent from the outer circumferential surface of the electrode assembly 100 and disposed on the second close contact member 220. The cap assembly 400 may seal the receiving can 300 so that the terminal plate 410 is disposed on the second close contact member 220. The second substrate tab 122 may be disposed between the second close contact member 220 and the terminal plate 410. According to this configuration, the terminal plate 410 may be electrically connected to the second electrode 120 through the second substrate tab 122 without a separate process such as welding.

According to an embodiment, in the process of sealing the receiving can 300, the cap assembly 400 may apply pressure to the second close contact member 220 and the electrode assembly 100. The second close contact member 220 may be compressed between the cap assembly 400 and the electrode assembly 100 by pressure transmitted from the cap assembly 400. As the second close contact member 220 is compressed, the second substrate tab 122 may be brought into close contact with the inner first surface of the cap assembly 400.

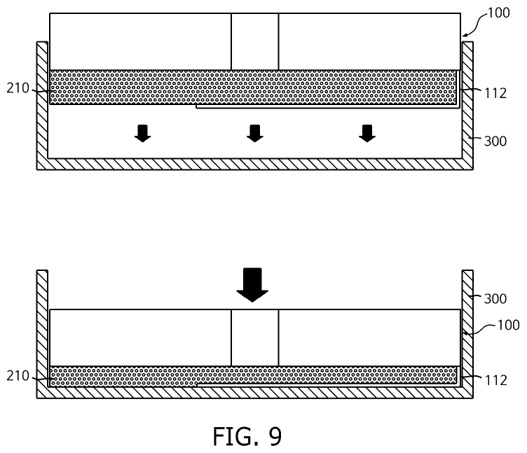

FIG. 9 illustrates the connection relationship between the electrode assembly and the receiving can according to some embodiments.

Referring to FIG. 9, according to an embodiment, the first close contact member 210 may be disposed under the electrode assembly 100. The first substrate tab 112 may be bent from the outer circumferential surface of the electrode assembly 100 and disposed under the first close contact member 210. In a case where the electrode assembly 100 is received in the receiving can 300, the first substrate tab 112 may be disposed between the first close contact member 210 and the receiving can 300. According to this configuration, the receiving can 300 may be electrically connected to the first electrode 110 through the first substrate tab 112 without a separate process such as welding.

According to an embodiment, in the process of sealing the receiving can 300, the cap assembly 400 may apply pressure to the first close contact member 210 and the electrode assembly 100. The first close contact member 210 may be compressed between the electrode assembly 100 and the receiving can 300 by pressure transmitted from the cap assembly 400. As the first close contact member 210 is compressed, the first substrate tab 112 may be pressed against the inner first surface of the receiving can 300.

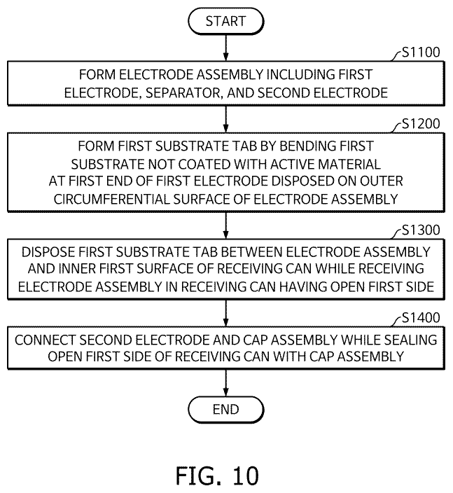

FIG. 10 illustrates a flowchart for explaining a method of manufacturing a secondary battery according to some embodiments. The method of manufacturing a secondary battery is described in detail below with reference to the secondary battery shown in FIGS. 1 to 3.

In step S1100 of FIG. 10, an electrode assembly including a first electrode 110, a second electrode 120, and a separator 130 may be formed. According to an embodiment, the electrode assembly 100 may be formed by winding the first electrode 110, the second electrode 120, and the separator 130 provided between the first electrode 110 and the second electrode 120.

In step S1200 of FIG. 10, a first substrate tab 112 may be formed by bending a first substrate not coated with an active material at a first end of the first electrode 110 disposed on the outer circumferential surface of the electrode assembly 100.

According to an embodiment, the first electrode 110 may include a coated portion 111 in a region where an active material is applied to opposite sides of the first substrate formed of a thin metal plate and an uncoated portion in a region where the active material is not applied and the substrate is exposed. The first electrode 110 may include the uncoated portion formed on opposite sides of the first substrate in a winding longitudinal direction. In addition, the first electrode 110 may include the uncoated portion formed by a predetermined length at the first end disposed on the outer surface of the electrode assembly 100.

The first substrate tab 112 may be formed by bending the uncoated portion of the first electrode 110 formed by a predetermined length at the first end of the first electrode 110. The first substrate tab 112 may be first bent to face the inner bottom of the receiving can 300 and may be subsequently bent to be disposed between the inner bottom of the electrode assembly 100 and the inner bottom of the receiving can 300. The first substrate tab 112 may be connected to the receiving can 300. The first substrate tab 112 may be disposed between the electrode assembly 100 and an inner first surface of the receiving can 300.

The step S1200 may further include disposing a first close contact member 210 between the electrode assembly 100 and the first substrate tab 112.

The first close contact member 210 may be disposed on the underside of the electrode assembly 100. Herein, the first close contact member 210 may include a resilient insulator. At the bottom of the first close contact member 210, the first-bent first substrate 112a may be subsequently bent upward. The second-bent first substrate 112a may be disposed on the underside of the first close contact member 210 to form the first substrate tab 112.

Step S1300 may include disposing the first substrate tab 112 between the electrode assembly 100 and the inner first surface of the receiving can 300 while receiving the electrode assembly 100 in the receiving can 300 having an open first side.

According to an embodiment, the receiving can 300 may have an open first side to receive the electrode assembly 100 and may be electrically connected to the first electrode 110. The receiving can 300 may be connected to the first substrate tab 112. The receiving can 300 may be connected to the first electrode 110 through the first substrate tab 112 to function as a negative electrode.

According to an embodiment, the first electrode 110 may include a first substrate including the uncoated portion not coated with an active material at a first end of the outer circumferential surface of the wound electrode assembly 100. On the outer circumferential surface of the electrode assembly 100, the first substrate 112a corresponding to the uncoated portion may be first bent downward.

Step S1400 of FIG. 10 may include connecting the second electrode 120 and the cap assembly 400 while sealing the open first side of the receiving can 300 with the cap assembly 400.

According to an embodiment, the upper surface opposite the lower surface of the receiving can 300 may be open to expose a receiving space capable of receiving the electrode assembly 100. After the electrode assembly 100 is received in the receiving can 300, the cap assembly 400 may seal the electrode assembly 100 while covering the open first side of the receiving can 300. Specifically, the upper surface of the sidewall of the receiving can 300 may have a portion stepped from the outside to the inside. For engagement with the stepped portion of the receiving can 300, the cap assembly 400 may be engaged and joined by metal bonding (e.g., welding, brazing, or soldering), but the present disclosure is not limited thereto.

According to an embodiment, the cap assembly 400 may seal the open first side of the receiving can 300. The cap assembly 400 may cover the open first side of the receiving can 300 to seal the electrode assembly 100 from the outside. The cap assembly 400 may be electrically connected to the second electrode 120. The cap assembly 400 may be connected to the second electrode 120 through the second substrate tab 122 to function as a positive electrode.

The method of manufacturing a secondary cell according to embodiments of the present disclosure may further include a step of forming a second substrate tab. The second substrate tab 122 may be formed by bending the uncoated portion formed by a predetermined length at a first end of the second electrode 120. The second substrate tab 122 may be first bent to face an inner first surface of the cap assembly 400, and may be subsequently bent to be disposed between the top surface of the electrode assembly 100 and the inner first surface of the cap assembly 400. The second substrate tab 122 may be connected to the cap assembly 400. The second substrate tab 122 may be disposed on the upper surface of the second close contact member 220. The second substrate tab 122 may be attached to the upper surface of the second close contact member 220 and may be connected to the cap assembly 400. The second substrate tab 122 may function as an electrode tab, and the second electrode 120 and the cap assembly 400 may be electrically connected through the second substrate tab 122.

In the secondary battery 1 manufactured in this manner, the occurrence of cracks in the electrode plates 110 and 120 may be reduced by forming the substrate tabs 112 and 122 from the substrates of the electrode plates 110 and 120 without connecting a separate collector tab to the electrode assembly 100. In addition, the resilient close contact members 210 and/or the resilient close contact members 220 may be disposed between the electrode assembly 100 and the receiving can 300 and/or between the electrode assembly 100 and the cap assembly 400 to protect the secondary cell from external impacts such as vibration or dropping.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

<Description of Reference Symbols>

| | |
|---|---|
| 1: secondary battery | 100: electrode assembly |
| 110: first electrode | 112: first substrate tab |
| 112a: first substrate | 122a: second substrate |
| 120: second electrode | 122: second substrate tab |
| 130: separator | 210: first close contact member |
| 220: second close contact member | 300: receiving can |
| 400: cap assembly | 410: terminal plate |
| 411: protrusion | 412: body |
| 420: cap plate | 430: cap insulating layer |

What is claimed is:

1. A secondary battery comprising:
an electrode assembly comprising a first electrode, a separator, and a second electrode;
a receiving can having an open first side to receive the electrode assembly and the receiving can being connected to the first electrode; and
a cap assembly configured to seal the open first side of the receiving can and being connected to the second electrode,
wherein the first electrode comprises a first substrate tab that is a bent portion of a first substrate not coated with an active material at a first end of the first electrode disposed on an outer circumferential surface of the electrode assembly, and
the first substrate tab is disposed between the electrode assembly and an inner first surface of the receiving can.

2. The secondary battery as claimed in claim 1, wherein the first substrate tab is first bent so that the first substrate disposed on the outer circumferential surface of the electrode assembly faces an inner bottom of the receiving can and is subsequently bent so that the first substrate is disposed between a bottom surface of the electrode assembly and the inner bottom of the receiving can.

3. The secondary battery as claimed in claim 1, further comprising a first close contact member disposed between the electrode assembly and the first substrate tab.

4. The secondary battery as claimed in claim 3, wherein the first close contact member comprises a resilient insulator.

5. The secondary battery as claimed in claim 3, wherein the first close contact member comprises a resilient porous material.

6. The secondary battery as claimed in claim 1, wherein the first substrate tab is brought into contact with the inner first surface of the receiving can by pressure transmitted from the electrode assembly during coupling between the cap assembly and the receiving can.

7. The secondary battery as claimed in claim 1, wherein the second electrode comprises a second substrate tab that is a bent portion of a second substrate not coated with an active material at a first end of the second electrode disposed on the outer circumferential surface of the electrode assembly, and
the second substrate tab is disposed between the electrode assembly and an inner first surface of the cap assembly.

8. The secondary battery as claimed in claim 7, wherein the second substrate tab is first bent so that the second substrate disposed on the outer circumferential surface of the electrode assembly faces the inner first surface of the cap assembly and is subsequently bent so that the bent second substrate is disposed between a top surface of the electrode assembly and the inner first surface of the cap assembly.

9. The secondary battery as claimed in claim 7, further comprising a second close contact member disposed between the electrode assembly and the second substrate tab.

10. The secondary battery as claimed in claim 9, wherein the second close contact member comprises a resilient insulator.

11. The secondary battery as claimed in claim 9, wherein the second close contact member comprises a resilient porous material.

12. The secondary battery as claimed in claim 7, wherein the second substrate tab is brought into contact with the inner first surface of the cap assembly by pressure transmitted from the electrode assembly during coupling between the cap assembly and the receiving can.

13. The secondary battery as claimed in claim 1, wherein the cap assembly comprises:
a terminal plate connected to the second electrode;
a cap plate configured to have a first open area and bonded to the open first side of the receiving can; and
a cap insulating layer configured to comprise a second open area and disposed between the terminal plate and the cap plate to insulate between the terminal plate and the cap plate.

14. The secondary battery as claimed in claim 13, wherein the terminal plate comprises:
a body connected to the second electrode; and
a protrusion configured to protrude upward from a central portion of the body to extend through the first open area of the cap plate.

15. The secondary battery as claimed in claim 14, wherein a diameter of the body of the terminal plate is greater than a diameter of the outer circumferential surface of the electrode assembly.

16. A method of manufacturing a secondary battery, the method comprising:
forming an electrode assembly comprising a first electrode, a separator, and a second electrode;
forming a first substrate tab by bending a first substrate not coated with an active material at a first end of the first electrode disposed on an outer circumferential surface of the electrode assembly;
disposing the first substrate tab between the electrode assembly and an inner first surface of a receiving can having an open first side while receiving the electrode assembly in the receiving can having the open first side; and
connecting the second electrode and a cap assembly together while sealing the open first side of the receiving can with the cap assembly.

17. The method as claimed in claim 16, wherein the forming of the first substrate tab comprises:
first bending the first substrate tab so that the first substrate disposed on the outer circumferential surface of the electrode assembly faces an inner bottom of the receiving can; and
subsequently, bending the first substrate tab so that the first substrate is disposed between a bottom surface of the electrode assembly and the inner bottom of the receiving can.

18. The method as claimed in claim 16, wherein in sealing the open first side of the receiving can with the cap assembly, the first substrate tab is brought into contact with the inner first surface of the receiving can by pressure transmitted from the electrode assembly during coupling between the cap assembly and the receiving can.

19. The method as claimed in claim 16, further comprising providing a first close contact member between the electrode assembly and the first substrate tab.

20. The method as claimed in claim 16, further comprising forming a second substrate tab by bending a second substrate not coated with an active material at a first end of the second electrode disposed on the outer circumferential surface of the electrode assembly,
wherein the connecting of the second electrode and the cap assembly while sealing the open first side of the receiving can with the cap assembly comprises disposing the second substrate tab between the electrode assembly and an inner first surface of the cap assembly while connecting the open first side of the receiving can to the cap assembly.
